(19) United States
(12) Patent Application Publication
(10) Pub. No.: US 2024/0078119 A1
(43) Pub. Date: Mar. 7, 2024

(54) Vehicle Setting System and Method

(71) Applicant: Hitachi Astemo, Ltd., Hitachinaka-shi, Ibaraki (JP)

(72) Inventors: Jairo LOPEZ, Tokyo (JP); Hidetoshi TERAOKA, Tokyo (JP); Takehiko NAGANO, Tokyo (JP); Mikio KATAOKA, Tokyo (JP)

(21) Appl. No.: 18/274,276

(22) PCT Filed: Aug. 18, 2021
(86) PCT No.: PCT/JP2021/030120

§ 371 Date: Jul. 26, 2023

(30) Foreign Application Priority Data
Feb. 4, 2021 (JP) 2021-016841

(51) Int. Cl. G06F 9/445; B60R 16/02; G06F 8/60

(52) U.S. Cl. CPC G06F 9/44505; B60R 16/02; G06F 8/60

(57) ABSTRACT

Function definition information is prepared in a system. The function definition information is information representing a correspondence relationship among a software-based function, a vehicle ID of a vehicle, a hardware configuration for implementing a function, and a software configuration for implementing a function. The system performs a preliminary determination including a determination of a relationship between one or a plurality of user-desired functions constituting a user-desired function group of a user and a hardware configuration of a target vehicle based on the function definition information. For each of the one or more functions specified in the preliminary determination, in order to implement the function in the target vehicle, the system develops a software configuration corresponding to the function in a hardware configuration corresponding to the function in the target vehicle.

### TECHNICAL FIELD

The present invention generally relates to a setting for a computer mounted on a vehicle.

### BACKGROUND ART

In general, a user wants a vehicle in which the user rides to be set as desired by the user. There is known a technology of performing a setting for an in-vehicle apparatus through a mobile terminal (for example, PTLs 1 to 3).

### CITATION LIST

### Patent Literature

PTL 1: JP 2011-223349 A
PTL 2: JP 2015-150966 A
PTL 3: JP 2016-000570 A

### SUMMARY OF INVENTION

### Technical Problem

Software dependency of functions of vehicles is increasing. For example, a vehicle includes an electronic control unit (ECU), and a function is implemented by software executed by the ECU. It is conceivable to use an over the air (OTA) technology to download the software for implementing the function desired by the user to the vehicle.

That is, as a user-desired setting for the vehicle, there is a software-based user-desired function setting.

However, in general, a software configuration for implementing a function varies depending on the function, and a hardware configuration in which the software is developed varies depending on the vehicle. Therefore, depending on a relationship between a user-desired function and the vehicle as an implementation destination of the function, it is not always possible to implement the user-desired function in the vehicle. None of PTLs 1 to 3 described above discloses or suggests such a specific problem regarding the implementation of the software-based function in the vehicle.

### Solution to Problem

Function definition information is prepared in a system. The function definition information is information representing a correspondence relationship among a software-based function, a vehicle ID of a vehicle, a hardware configuration for implementing a function, and a software configuration for implementing a function. The system performs a preliminary determination including a determination of a relationship between one or a plurality of user-desired functions constituting a user-desired function group of a user and a hardware configuration of a target vehicle based on the function definition information. For each of the one or more functions specified in the preliminary determination, in order to implement the function in the target vehicle, the system develops a software configuration corresponding to the function in a hardware configuration corresponding to the function in the target vehicle.

### Advantageous Effects of Invention

According to the present invention, it is possible to expect improvement in reliability of implementing a software-based user-desired function in a vehicle.

### BRIEF DESCRIPTION OF DRAWINGS

FIG. 1 illustrates a configuration of an entire system according to a first embodiment.

FIG. 2 illustrates a configuration example of an ECU.

FIG. 3 illustrates a configuration example of an HECU.

FIG. 4 illustrates an example of a software configuration in an ECU ROM.

FIG. 5 illustrates a configuration example of an EUC gateway.

FIG. 6 illustrates a configuration example of an OTA server system.

FIG. 7 illustrates a configuration example of a user device.

FIG. 8 illustrates a configuration example of a function definition table.

FIG. 9 illustrates a configuration example of a software definition table.

FIG. 10 illustrates a configuration example of a vehicle configuration table.

FIG. 11 illustrates a configuration example of a user setting table.

FIG. 12 illustrates a configuration example of a user-side software table.

FIG. 13 illustrates an example of a flow of entire processing performed in the first embodiment.

FIG. 14 illustrates an example of a flow of S106 in FIG. 13.

FIG. 15 illustrates an example of a flow of S107 in FIG. 13.

FIG. 16 illustrates an example of a flow of S108 in FIG. 13.

FIG. 17 illustrates an example of a flow of entire processing performed in a second embodiment.

### DESCRIPTION OF EMBODIMENTS

In the following description, an “interface apparatus” may be one or more interface devices. The one or more interface devices may be at least one of the following.
One or more input/output (I/O) interface devices. The input/output (I/O) interface device is an interface device for at least one of the I/O device and a remote display computer. The I/O interface device for the display computer may be a communication interface device. The at least one I/O device may be any of a user interface device, for example, an input device such as a keyboard and a pointing device, and an output device such as a display device.
One or more communication interface devices. The one or more communication interface devices may be one or more communication interface devices of a same type (for example, one or more network interface cards (NIC)) or two or more communication interface devices of different types (for example, NIC and host bus adapter (HBA)).

In addition, in the following description, a “memory” is one or more memory devices that are an example of one or more storage devices, and may typically be a main storage device. The at least one memory device in the memory may be a volatile memory device or a non-volatile memory device.

In addition, in the following description, a “permanent storage apparatus” may be one or more permanent storage devices that are an example of the one or more storage devices. Typically, the permanent storage device may be a non-volatile storage device (for example, an auxiliary storage device), and specifically, for example, may be a hard disk drive (HDD), a solid state drive (SSD), a non-volatile memory express (NVME) drive, or a storage class memory (SCM).

In addition, in the following description, a “storage apparatus” may be at least a memory of the memory and the permanent storage apparatus.

In addition, in the following description, a “processor” may be one or more processor devices. The at least one processor device may typically be a microprocessor device such as a central processing unit (CPU), but may be another type of processor device such as a graphics processing unit (GPU). The at least one processor device may be a single core or a multi-core. The at least one processor device may be a processor core. The at least one processor device may be a processor device in a broad sense such as a circuit (for example, a field-programmable gate array (FPGA), a complex programmable logic device (CPLD), or an application specific integrated circuit (ASIC)) that is an aggregate of gate arrays in a hardware description language that performs a part or all of processing.

In addition, in the following description, information from which an output is obtained with respect to an input will be described with an expression such as “xxx table”. However, the information may be data of any structure (for example, it may be structured data or unstructured data), or may be a learning model represented by a neural network, a genetic algorithm, or a random forest that generates an output with respect to an input. Therefore, the “xxx table” can be referred to as “xxx information”. In addition, in the following description, the configuration of each table is an example, and one table may be divided into two or more tables, or all or a part of two or more tables may be one table.

In addition, in the following description, there is a case where processing is described with a “program” as a subject, but the subject of the processing may be a processor (or an apparatus or a system including the processor) since the program is executed by the processor to perform defined processing appropriately using the storage apparatus and/or the interface apparatus. The program may be installed in an apparatus such as a computer from a program source. The program source may be, for example, a program distribution server or a computer-readable recording medium (for example, a non-transitory recording medium). In addition, in the following description, two or more programs may be implemented as one program, or one program may be implemented as two or more programs.

In addition, in the following description, in a case where the same type of elements are described without being distinguished, common reference numerals among the reference numerals may be used, and in a case where the same type of elements are described while being distinguished, reference numerals may be used. For example, an electronic control unit (ECU) may be referred to as an “ECU C10” when described without being particularly distinguished, and may be referred to as an “ECU C10-01” or an “ECU C10-02” when describing individual ECUs by distinguishing them from each other.

In addition, in the following description, a “vehicle” may be any vehicle that can be used by a plurality of users, and may be, for example, any of a private car, a vehicle that is a rental or sharing target, and a free vehicle.

In addition, in the following description, a “user” may be a user who is a driver or a passenger in the vehicle.

In addition, in the following description, an “ID” is identification information, and may be identification information in a narrow sense that can uniquely identify an element, or may be identification information in a broad sense such as a name of an element. For example, the vehicle ID may include at least a vehicle name out of a vehicle identification number and a vehicle name.

### First Embodiment

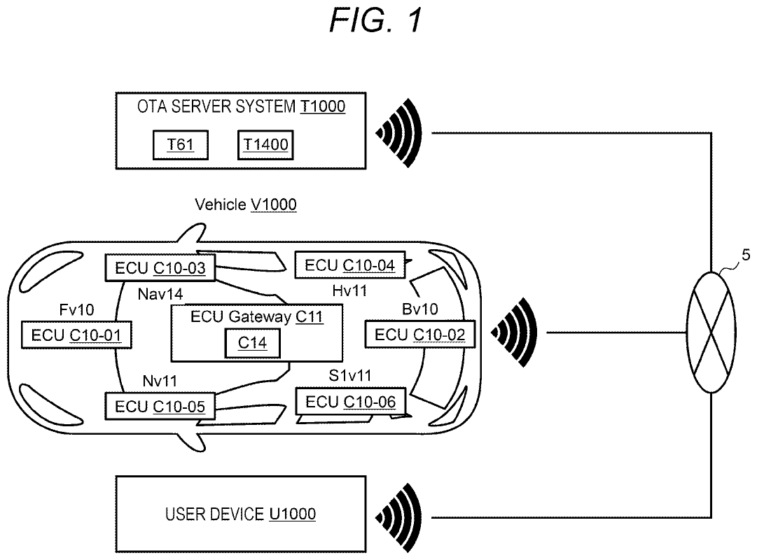

FIG. 1 illustrates a configuration of an entire system according to a first embodiment.

A vehicle V1000, a user device U1000, and an OTA server system T1000 can communicate via a network 5 (for example, the Internet). At least one of the vehicle V1000, the user device U1000, and the OTA server system T1000 may be communicable by short-range wireless communication or the like instead of or in addition to the network 5.

The vehicle V1000 includes a plurality of computer devices, specifically, a plurality of ECUs C10 (for example, six ECUs C10-01 to C10-06) and an ECU gateway C11 coupled to the plurality of ECUs C10. Note that the at least one ECU C10 may have a function of the ECU gateway C11 and may not be provided with the ECU gateway C11. In addition, in FIG. 1, a character string (for example, “Fv10”, “Bv10”, . . . ) described in the vicinity of the ECU C10 represents a version of the ECU C10.

The user device U1000 is an information processing device of the user and is a device capable of communicating with the vehicle V1000. The user device U1000 may be a personal computer (for example, a desktop personal computer, a laptop personal computer, or a tablet personal computer) or a smartphone. The user device U1000 may be omitted.

The OTA server system T1000 is a server system that distributes software or information for update thereof according to the over the air (OTA) technology.

In the vehicle setting system according to the present embodiment, a function definition table T1400 is prepared in the OTA server system T1000. The function definition table T1000 is a table representing a correspondence relationship among a software-based function, a vehicle ID of a vehicle, a hardware configuration for implementing a function, and a software configuration for implementing a function. A preliminary determination program T61 is executed by the OTA server system T1000, and a function setting program C14 is executed by the ECT gateway C11. The preliminary determination program T61 performs a preliminary determination including a determination of a relationship between one or a plurality of user-desired functions constituting a user-desired function group of the user and the hardware configuration of the vehicle V1000 based on the function definition table T1000. For each of the one or more functions specified in the preliminary determination, in order to implement the function in the vehicle V1000, the function setting program C14 develops a software configuration corresponding to the function in the hardware configuration corresponding to the function in the vehicle V1000. As described above, in a case where there is the hardware configuration corresponding to the user-desired function in the vehicle V1000, the software configuration corresponding to the function is developed in the hardware configuration. Therefore, it can be expected that the reliability of implementing the software-based user-desired function in the vehicle V1000 is improved.

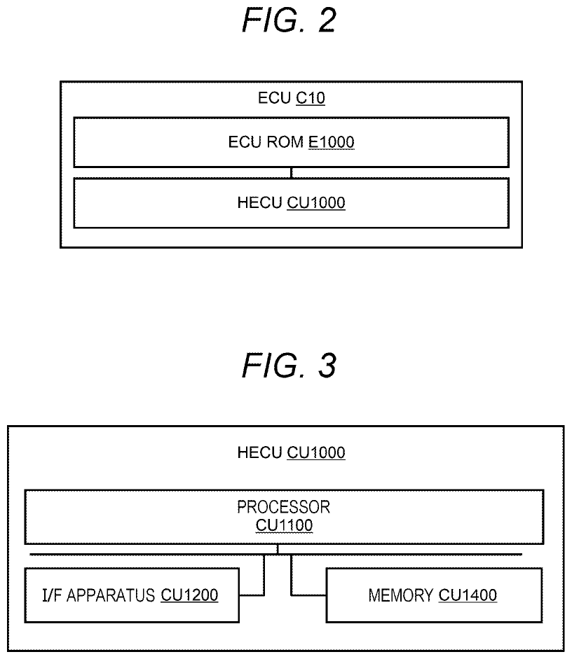

FIG. 2 illustrates a configuration example of the ECU C10.

The ECU C10 includes an HECU CU1000 (an example of a controller) and an ECU ROM E1000 coupled to the HECU CU1000.

The “HECU” is an abbreviation for High performance ECU. At least one of one or a plurality of cameras mounted on the vehicle V1000 may be coupled to the HECU CU1000.

A “ROM” of the ECU ROM E1000 is an abbreviation for read only memory, and the ECU ROM E1000 is an example of a rewritable memory, and is specifically a flash ROM. A storage apparatus (for example, the ECU ROM E1000 and the permanent storage apparatus) including the ECU ROM E1000 may be provided.

FIG. 3 illustrates a configuration example of the HECU CU1000.

The HECU CU1000 includes an interface apparatus CU1200, a memory CU1400, and a processor CU1100 coupled thereto. A storage apparatus (for example, the memory CU1400 and the permanent storage apparatus) including the memory CU1400 may be provided.

The interface apparatus CU1200 may include a plurality of communication interface devices, for example, an interface device for short-range wireless communication, an interface device for wireless local area network (for example, WiFi (registered trademark)) (LAN) communication, and a communication interface device coupled to a camera not illustrated. The memory CU1400 may include a plurality of memory devices. The processor CU1100 may include a plurality of CPUs. Each of the interface apparatus CU1200, the memory CU1400, and the processor CU1100 may have a heterogeneous configuration or a homogeneous configuration.

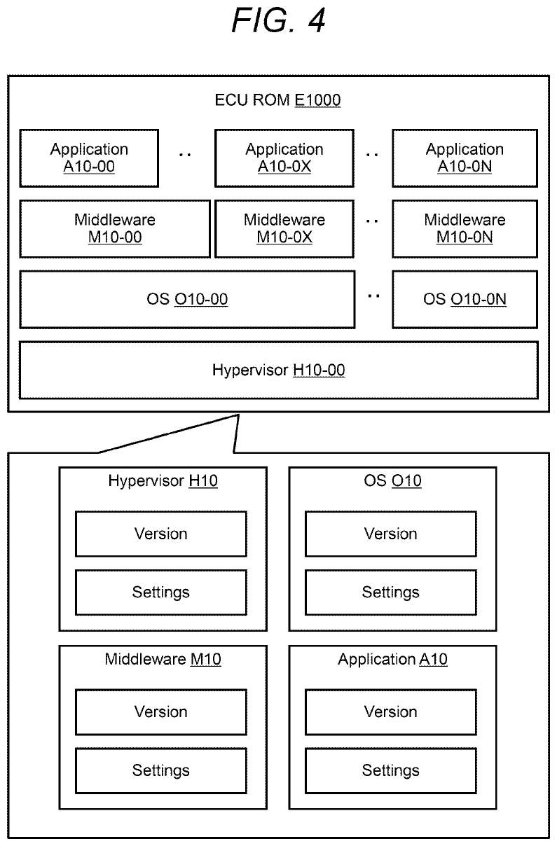

FIG. 4 illustrates an example of a software configuration in the ECU ROM E1000.

In the present embodiment, the elements of the “software configuration” may include programs such as a hypervisor H10, an operating system (OS) 010, a middleware M10, and an application A10. The hypervisor H10 may execute one or more virtual computers not illustrated, and the OS 010, the middleware M10, and the application A10 may be executed in each virtual computer. Instead of or in addition to the virtual computer, another type of execution environment such as a container may be developed, and the middleware M10 or the application A10 may be executed in the execution environment. Apart of the software configuration illustrated in FIG. 4 may be omitted, or elements not illustrated in FIG. 4 may be included in the software configuration. For example, none of the hypervisor H10, the OS 010, the middleware M10, and the application A10 is limited to the illustrated number.

Each program included in the software configuration includes a version of the program and a setting for the program. The version and setting of each program affect the operation of the program, and as a result, affect the function implemented by executing the software configuration including the program.

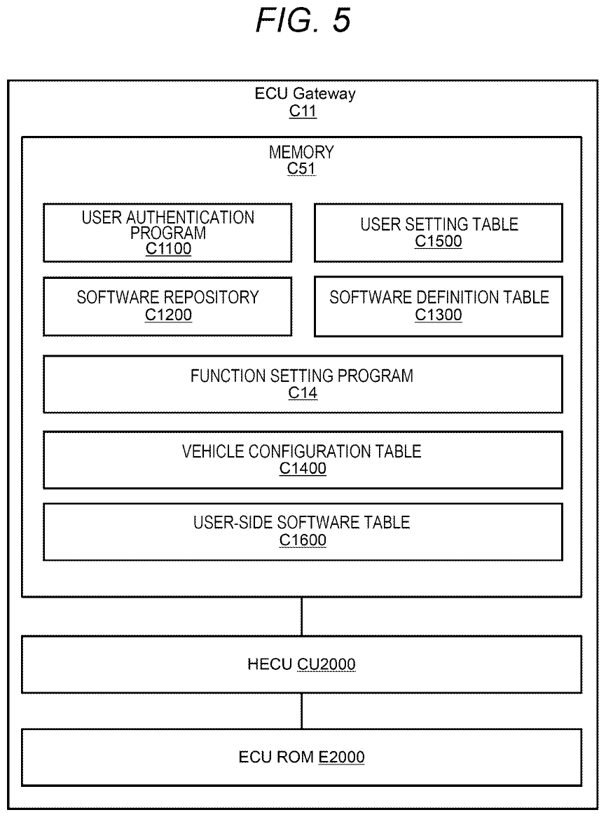

FIG. 5 illustrates a configuration example of an EUC gateway C11.

The EUC gateway C11 includes an ECU ROM E2000, a memory C51, and an HECU CU2000 coupled thereto. A storage apparatus including the ECU ROM E2000 may be provided, or a storage apparatus including the memory C51 may be provided. By the ECU ROM E2000 and the HECU CU2000, the EUC gateway C11 may perform processing as an ECU (for example, execution of each program in the software configuration) in addition to processing as a gateway (for example, control of input/output of information between an external device such as at least one of the OTA server system T1000 and the user device U1000 and the ECU C10). For example, the interface apparatus included in the HECU CU2000 includes one or more interface devices coupled to the plurality of ECUs C10 in the vehicle V1000.

The memory C51 includes a software repository C1200. The software repository C1200 can store programs in the software configuration developed in the ECU ROM 2000 or the ECU C10 (for example, the ECU ROM E1000).

The memory C51 stores management information such as a software definition table C1300, a vehicle configuration table C1400 a user setting table C1500, and a user-side software table C1600. The software definition table C1300 represents a software configuration that can be partially updated. The vehicle configuration table C1400 represents a hardware configuration of the vehicle V1000. The user setting table C1500 represents a user-desired function and a setting for the function. The user-side software table C1600 represents a user-desired function group (one or more software-based user-desired functions). Details of each of the tables C1300, C1400, C1500, and C1600 will be described later.

The memory C51 stores programs such as a user authentication program C1100 and a function setting program C14. These programs are executed by the processor in the HECU CU2000. The user authentication program C1100 permits access (access to the OTA server system T1000) for changing the software configuration in the at least one ECU C10 to a different software configuration. The function setting program C14 develops a software configuration corresponding to a function in the ECU C10 having a hardware configuration corresponding to the function.

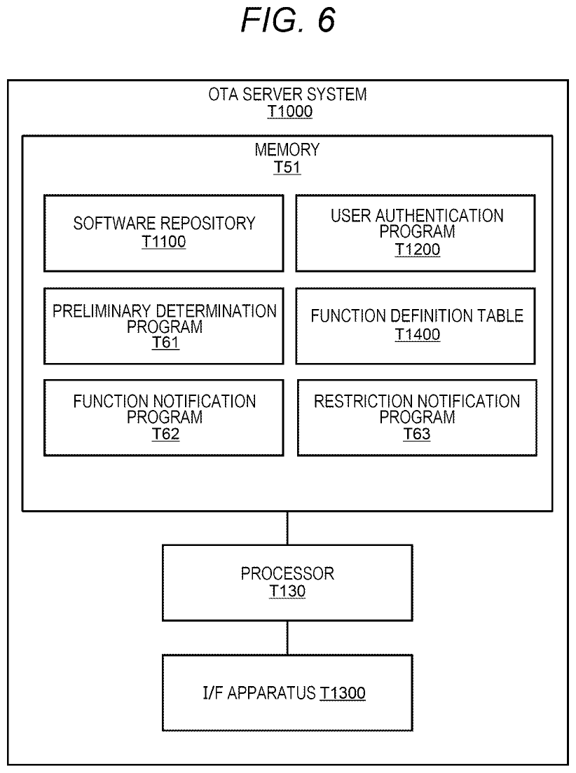

FIG. 6 illustrates a configuration example of the OTA server system T1000.

The OTA server system T1000 provides a requested program according to the over the air (OTA) technology. The OTA server system T1000 may be an example of a server system of a company or an original equipment manufacturer (OEM) that provides a rental or sharing service of the vehicle V1000. The OTA server system T1000 may be a physical computer system (one or more physical computers) including an interface apparatus T1300, a storage apparatus including a memory T51, and a processor T130 coupled thereto, or may be a logical computer system (for example, a system as a cloud computing service) based on the physical computer system (for example, a cloud infrastructure).

Through the I/F apparatus T1300, it is possible to communicate with at least one of the vehicle V1000 (ECU gateway C11) and the user device U1000.

The memory T51 includes a software repository T1100. A program that can be provided may be stored in the software repository T1100.

The memory T51 stores management information such as a function definition table T1400. Details of the function definition table T1400 will be described later.

The memory T51 stores programs such as a user authentication program T1200, a preliminary determination program T61, a function notification program T62, and a restriction notification program T63. These programs are executed by the processor T130. The user authentication program T1200 authenticates and authorizes access from the ECU gateway C11 or the user device U1000. The preliminary determination program T61 performs the above-described preliminary determination. The function notification program T62 notifies the vehicle V1000 (ECU gateway C11) of information representing one or more functions specified in the preliminary determination. In a case where at least a part of the one or more functions specified in the preliminary determination is not a user-desired function, the restriction notification program T63 notifies the user of function restriction information that is information representing the part of the functions.

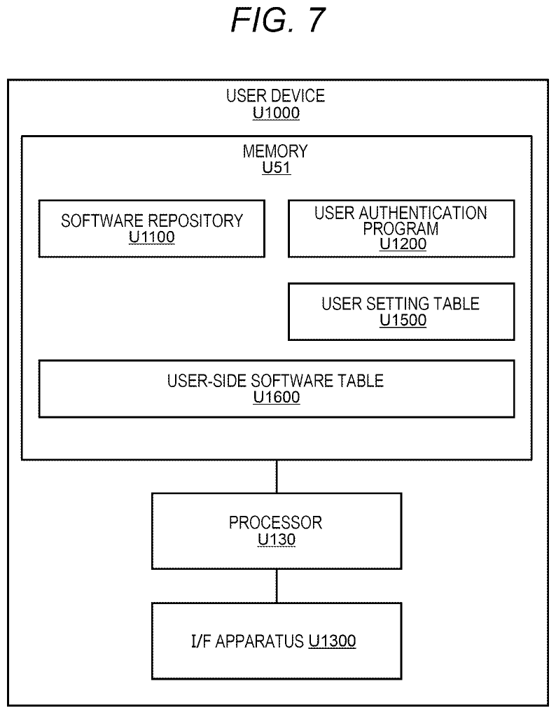

FIG. 7 illustrates a configuration example of the user device U1000.

The user system TU000 includes an interface apparatus U1300, a storage apparatus including a memory U51, and a processor U130 coupled thereto.

Through the I/F apparatus U1300, communication with at least one of the vehicle V1000 (ECU gateway C11) and the OTA server system T1000 is possible.

The memory TU1 includes a software repository U1100. The software repository U1100 can store a program in the software configuration developed in the ECU gateway C11 (for example, the ECU ROM 2000) or the ECU C10 (for example, the ECU ROM E1000).

The memory U51 stores management information such as a user setting table U1500 and a user-side software table U1600. The configurations of the user setting table U1500 and the user-side software table U1600 may be the same as the configurations of the user setting table C1500 and the user-side software table C1600 in the ECU gateway C11, respectively.

The memory U51 stores a program such as a user authentication program U1200. The user authentication program U1200 permits access (access to the OTA server system T1000) for changing the software configuration in the at least one ECU C10 to a different software configuration.

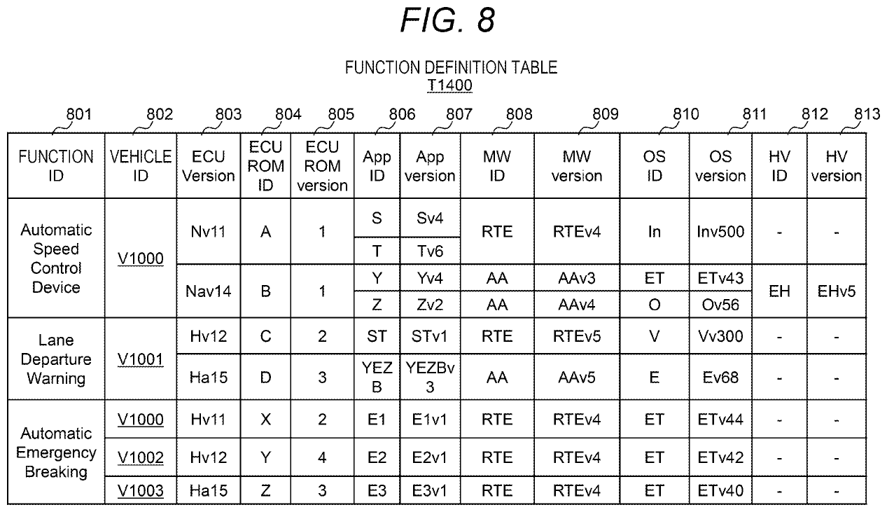

FIG. 8 illustrates a configuration example of the function definition table T1400.

The function definition table T1400 is a table representing a correspondence relationship among a software-based function, a vehicle ID, a hardware configuration for implementing a function, and a software configuration for implementing a function. Various functions, for example, functions related to automatic driving and other functions may be adopted as the software-based function.

The function definition table T1400 has, for example, an entry for each software-based function. Each entry holds information such as a function ID 801, a vehicle ID 802, an ECU version 803, an ECU ROM ID 804, an ECU ROM version 805, an application ID 806, an application version 807, a middleware ID 808, a middleware version 809, an OS ID 810, an OS version 811, a hypervisor ID 812, and a hypervisor version 813. The information 801 is information representing a function. The information 802 is information representing the vehicle ID. The pieces of information 803 to 805 are information representing a hardware configuration. The pieces of information 806 to 813 are information representing a software configuration. One function is taken as an example (“function of interest” in the description of FIG. 8).

The function ID 801 represents an ID (for example, a name) of the function of interest. The vehicle ID 802 represents a vehicle ID of each of one or more vehicles that can be an implementation destination of the function of interest. The ECU version 803 represents a version of each of one or more ECUs (an ECU that exists in the vehicle and in which a software configuration corresponding to the function of interest is developed) for each vehicle that can be the implementation destination of the function of interest.

For each ECU corresponding to the function of interest, the ECU ROM ID 804 represents an ID of an ECU ROM to which the software configuration corresponding to the function of interest is developed, and the ECU ROM version 805 represents a version of the ECU ROM.

In addition, for each ECU corresponding to the function of interest, the pieces of information 806 to 813 represent a software configuration developed in the ECU. Specifically, the application ID 806 represents an ID (for example, a name) of an application, the application version 807 represents a version of the application, the middleware ID 808 represents an ID (for example, a name) of middleware, the middleware version 809 represents a version of the middleware, the OS ID 810 represents an ID (for example, a name) of an OS, the OS version 811 represents a version of the OS, the hypervisor ID 812 represents an ID (for example, a name) of a hypervisor, and the hypervisor version 813 represents a version of the hypervisor.

In the present embodiment, the hardware configuration corresponding to the software-based function implemented in the vehicle depends on the ECU (for example, the ECU version and the version of the ECU ROM) mounted on the vehicle, and the software configuration corresponding to the function depends on a combination of programs (for example, the type of the program and the version of the program). In other words, unlike general software installation in which only a substantial condition is that a predetermined OS exists and a hardware configuration does not matter, there is a specific problem in implementing the software-based function in the vehicle, and such a problem can be solved by processing including the above-described preliminary determination by defining the relationship between the hardware configuration and the software configuration for each function as illustrated in FIG. 8.

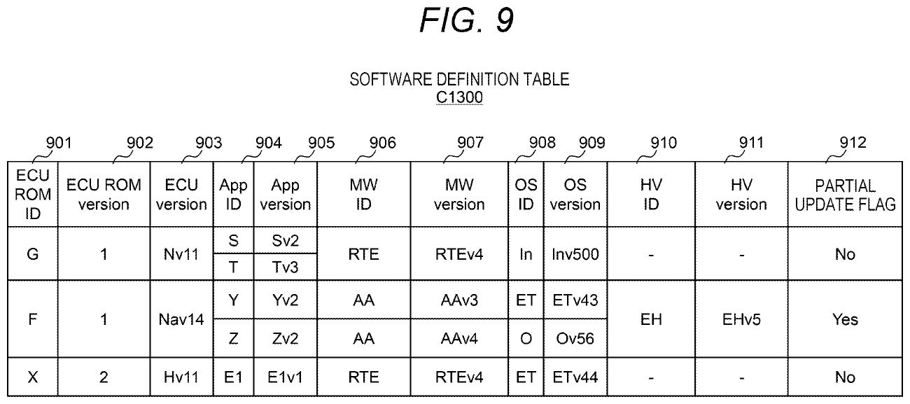

FIG. 9 illustrates a configuration example of the software definition table C1300.

The software definition table C1300 has, for example, an entry for each software configuration. Each entry holds information such as an ECU ROM ID 901, an ECU ROM version 902, an ECU version 903, an application ID 904, an application version 905, a middleware ID 906, a middleware version 907, an OS ID 908, an OS version 909, a hypervisor ID 910, a hypervisor version 911, and a partial update flag 912. One software configuration is taken as an example (“software configuration of interest” in the description of FIG. 9).

The pieces of information 901 to 903 are information representing a hardware configuration in which the software configuration of interest is developed. The pieces of information 901 to 903 are the same information as the pieces of information 804, 805, and 803 described above.

The pieces of information 904 to 911 are information representing the software configuration of interest. The pieces of information 904 to 911 are the same information as the pieces of information 806 to 813 described above.

The partial update flag 912 is information representing whether partial update of the software configuration of interest is possible. “Yes” means that the partial update is possible, and “No” means that the partial update is impossible. The “partial update” includes at least one of adding a program to the software configuration in the ECU ROM, deleting a program from the software configuration in the ECU ROM, and updating a part of the programs in the software configuration in the ECU ROM. That is, the “partial update” is to develop the software configuration in the ECU ROM without erasing the entire ECU ROM.

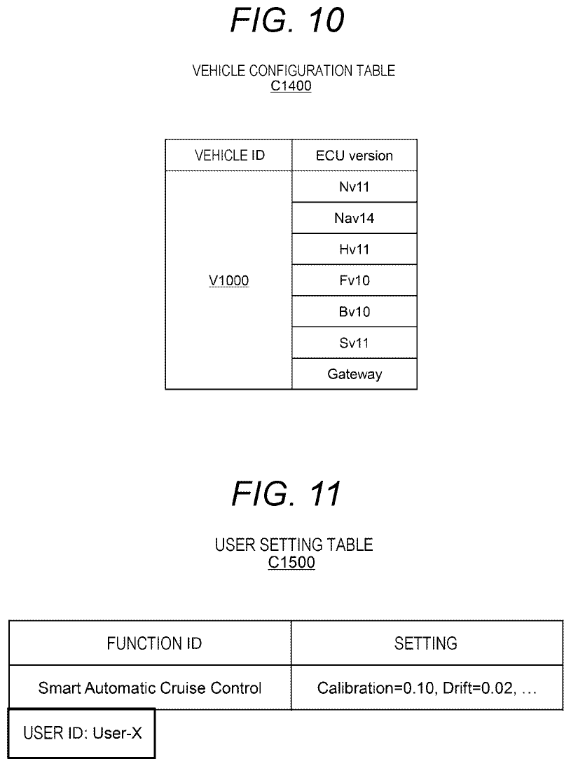

FIG. 10 illustrates a configuration example of the vehicle configuration table C1400.

The vehicle configuration table C1400 represents information representing the vehicle ID of the vehicle V1000 having the table C1400 and the ECU version of each ECU C10 of the vehicle V1000.

FIG. 11 illustrates a configuration example of the user setting table C1500.

The user setting table C1500 is an example of information representing a user-desired function group. The user setting table C1500 exists, for example, for each user. A user ID of a corresponding user is associated with the user setting table C1500. The user setting table C1500 includes, for each user-desired function, information representing an ID (for example, a name) of the function and a setting (for example, a parameter value set for each of one or more parameter items) for the function.

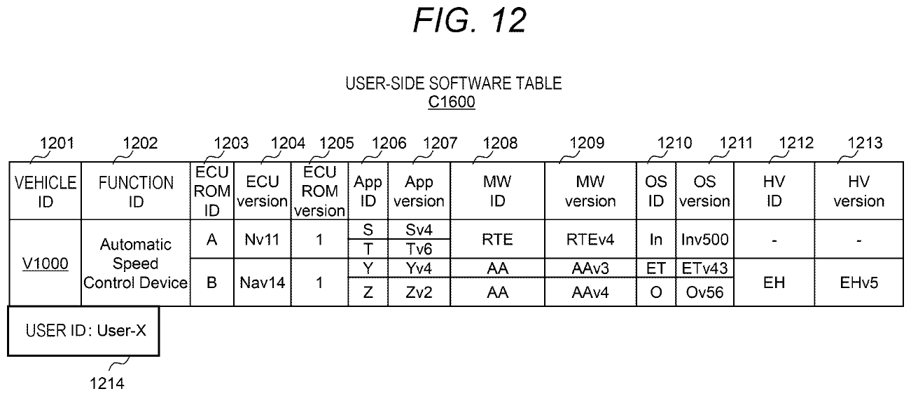

FIG. 12 illustrates a configuration example of the user-side software table C1600.

The user-side software table C1600 is an example of information representing a relationship between the vehicle and the user-desired function group. The user-side software table C1600 exists, for example, for each user. A user ID of a corresponding user is associated with the user-side software table C1600. The user-side software table C1600 has an entry for each vehicle. The “vehicle” referred to here may be a vehicle that the user has ridden in the past or a vehicle that the user plans to ride in the future. The user-side software table C1600 represents, for each vehicle selected by the user, a user-desired function group that is desired to be implemented in the vehicle.

In the user-side software table C1600, each entry holds information such as a vehicle ID 1201, a function ID 1202, an ECU ROM ID 1203, an ECU version 1204, an ECU ROM version 1205, an application ID 1206, an application version 1207, a middleware ID 1208, a middleware version 1209, an OS ID 1210, an OS version 1211, a hypervisor ID 1212, and a hypervisor version 1213. The information 1201 represents an ID of a vehicle, the information 1202 represents a user-desired function, the pieces of information 1203 to 1205 represent a hardware configuration in which a software configuration corresponding to the function is developed, and the pieces of information 1206 to 1213 represent a software configuration corresponding to the function.

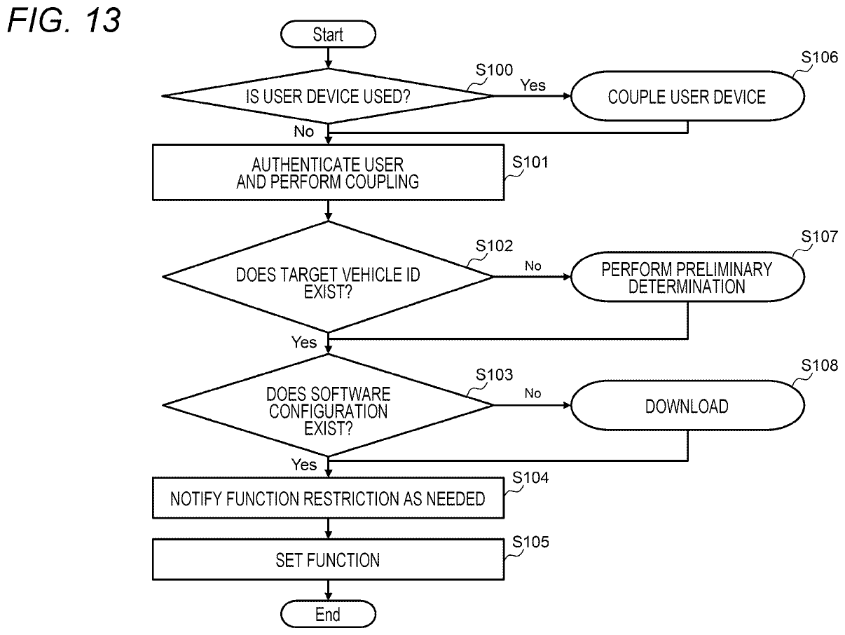

FIG. 13 illustrates an example of a flow of the entire processing performed in the present embodiment.

In a case where the user does not use the user device U1000 (S100: No), S101 is performed, but in a case where the user uses the user device U1000 (S100: Yes), S101 is performed through S106. In S106, the user device U1000 and the ECU gateway C11 of the vehicle V1000 are communicably coupled. Details of S106 will be described later.

In S101, the user is authenticated by the user authentication program C1100 in the ECU gateway C11 having the vehicle ID of the vehicle V1000 and the user authentication program T1200 in the OTA server system T1000 having the vehicle ID of the same vehicle V1000, and the ECU gateway C11 and the OTA server system T1000 are communicably coupled.

In S102, the preliminary determination program T61 receives the vehicle ID of the vehicle V1000 and the information in the user-side software table C1600, and determines whether the entry including the vehicle ID is in the user-side software table C1600. When the determination result of S102 is false, S103 is performed through S107 (preliminary determination). When the determination result of S102 is true, S103 is performed without S107. Details of S107 will be described later.

In S103, it is determined whether all programs in the software configuration to be developed exist in the software repository of either the ECU gateway C11 or the user device U1000. This determination may be performed by a predetermined program in the ECU gateway C11 and the user device U1000. When the determination result in S103 is false, a missing program is downloaded in S108, and then S104 is performed. When the determination result of S103 is true, S104 is performed without S108. Details of S108 will be described later.

In S104, when S107 is performed and a part of the one or more functions specified in S107 is not a user-desired function, the restriction notification program T63 notifies the user of function restriction information that is information representing the part of the functions. The function restriction information may be displayed on a display device (for example, a display device of an in-vehicle apparatus) in the vehicle V1000 through the ECU gateway C11, or may be transmitted to the user device U1000 and displayed. When the user's approval for the function restriction information is obtained (for example, in a case where the restriction notification program T63 has received approval from the user through the ECU gateway C11 or the user device U1000), S105 is performed. In a case where S107 has not been performed, or in a case where all of the one or more functions specified in S107 are the user-desired functions, S105 is performed without S104.

In S105, for each of the one or more functions, the function setting program C14 develops a software configuration corresponding to the function in a hardware configuration corresponding to the function in the vehicle V1000 in order to implement the function in the vehicle V1000 (for example, from the software repository in the ECU gateway C11 or the user device U1000, each program in the software configuration is developed in the ECU ROM of the corresponding ECU). Specifically, for example, the function notification program T62 may notify the ECU gateway C11 of the function and information representing the hardware configuration and the software configuration corresponding to the function, for the function specified in the preliminary determination (the function selected in S304 described later in the preliminary determination), and the function setting program C14 may develop each program in the software configuration corresponding to the function in the ECU ROM of the ECU corresponding to the hardware configuration corresponding to the function.

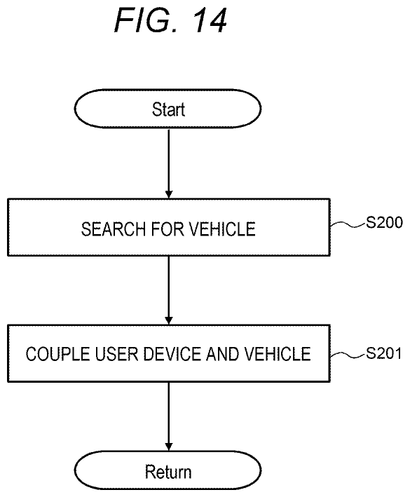

FIG. 14 illustrates an example of a flow of S106 in FIG. 13.

In S200, the user device U1000 searches for the vehicle V1000 by using a communication medium (for example, wireless LAN or short-range wireless communication) usable by the user device U1000. In S201, the user device U1000 is communicatively coupled to the ECU gateway C11 of the vehicle V1000 via the communication medium used to discover the vehicle V1000.

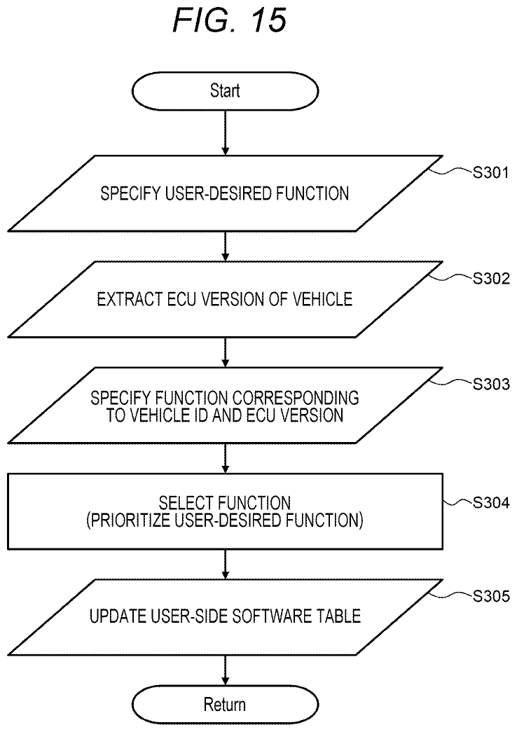

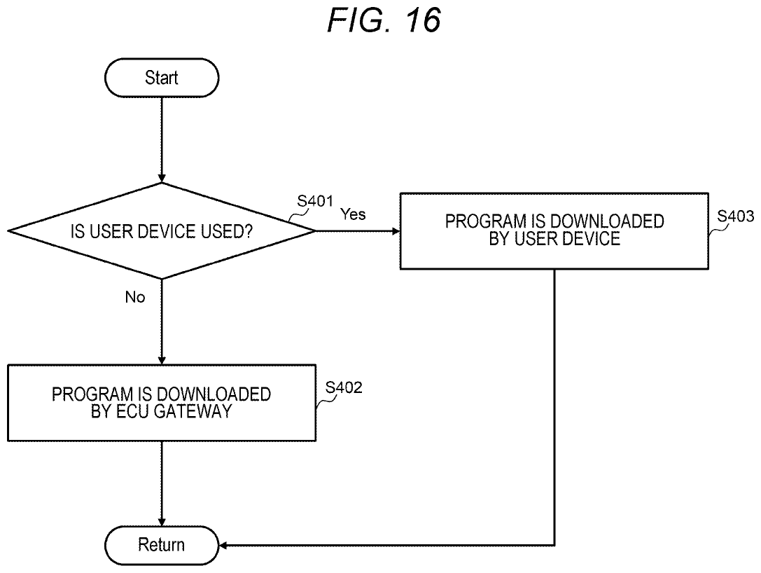

FIG. 15 illustrates an example of a flow of S107 in FIG. 13.

In S301, the preliminary determination program 161 specifies a function ID from the user setting table C1500.

In S302, the preliminary determination program T61 specifies all ECU versions of the vehicle V1000 from the vehicle configuration table C1400.

In S303, the preliminary determination program 161 specifies a function ID of the function corresponding to the hardware configuration including the ECU version extracted in S302 among all the functions corresponding to the vehicle ID of the vehicle V1000 from the function definition table T1400. Note that the vehicle ID of the vehicle V1000 may be a vehicle ID designated by the user, or may be a vehicle ID notified from the ECU gateway C11 of the vehicle V1000 in which the user has ridden.

In S304, the preliminary determination program T61 receives selection of a function from the user among the functions represented by all the function IDs specified in S303. For example, the preliminary determination program T61 may provide all the function IDs specified in S303 through the ECU gateway C11 or the user device U1000, and receive selection of a desired function ID from the user. Before or after receiving the selection, the preliminary determination program 161 may assign a relatively high priority to the same function as the user-desired function specified in S301 among the functions specified in S303. In addition, for example, instead of or in addition to the user setting table C1500, the preliminary determination program. T61 may regard the function ID specified from the user-side software table C1600 as a function ID of the user-desired function. That is, when the user-desired function group is registered for the vehicle V1000 because the user-desired function group is not registered for the vehicle V1000, at least a part of functions of the user-desired function group corresponding to another vehicle may be diverted as the user-desired functions for the vehicle V1000.

In S305, the preliminary determination program T61 adds an entry including the function IDs of all the functions selected in S304 and the vehicle ID of the vehicle V1000 to the user-side software table C1600. Among all the functions selected in S304, the function to which a relatively high priority is assigned may be associated with information representing a high priority in the user-side software table C1600. In addition, for each function selected in S304, the hardware configuration and the software configuration corresponding to the function may be specified from the function definition table 11400 and registered in the user-side software table C1600.

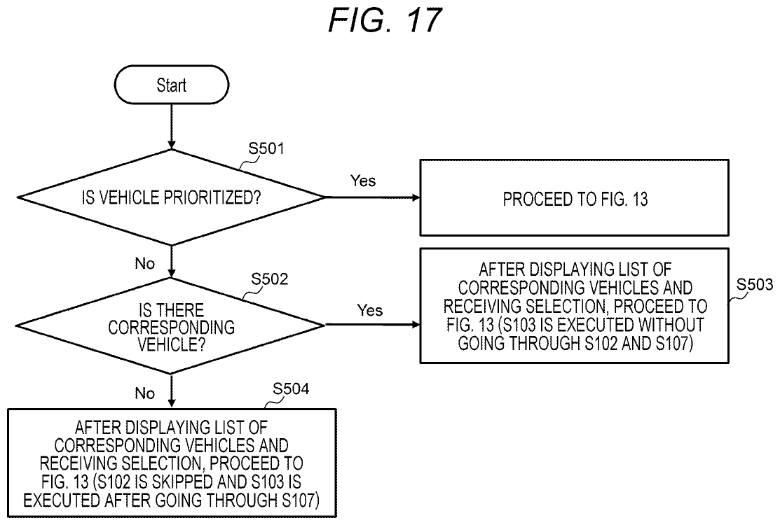

FIG. 16 illustrates an example of a flow of S108 in FIG. 13.

When the user device U1000 is not used (S401: No), the ECU gateway C11 downloads a program from the OTA server system T1000 (or another server system) to the software repository C1200 in S402.

In a case where the user device U1000 is used (S401: Yes), the user device U1000 downloads the program from the OTA server system T1000 (or another server system) to the software repository U1100 in S403.

According to the above flow, when the user-desired function group corresponding to the vehicle V1000 is not registered, a function corresponding to the hardware configuration included in the hardware configuration of the vehicle V1000 is specified among the software-based functions in the preliminary determination, and a software configuration corresponding to the function is developed in the hardware configuration corresponding to the function, so that the function is implemented in the vehicle V1000. As a result, it is possible to expect improvement in reliability of implementation of the software-based user-desired function in the vehicle V1000.

In addition, when the user-desired function group corresponding to the vehicle V1000 is registered, the user-desired function group can be implemented in the vehicle V1000 without S107 (preliminary determination). That is, quick function implementation is expected.

In addition, in a case where S107 is performed and a part of one or more functions output after the preliminary determination are not the user-desired functions (for example, in a case where a part of functions are not associated with a high priority), the restriction notification program T63 notifies the user of function restriction information that is information representing the part of functions in S104. As a result, the user can determine whether there is a function different from the user-desired function among the functions implemented in the vehicle V1000 and whether the function is acceptable, and control whether to implement the function group including such different functions.

The following processing may be performed in S105. That is, for each function, when there is no part of the software configuration corresponding to the function in the vehicle V1000 (S103: No), the function setting program C14 may determine whether partial update of the software configuration corresponding to the function is possible based on the software definition table C1300 in S105. When a result of the determination is true, the development of the software configuration corresponding to the function may include the partial update of the software configuration in the ECU ROM of the vehicle V1000. When the result of the determination is false, the development of the software configuration corresponding to the function may include deletion of the entire software configuration in the ECU ROM of the vehicle V1000 and development of the entire software configuration corresponding to the function in the ECU ROM. As described above, when there is a software configuration that can be partially updated, the partial update is performed, which contributes to quick function implementation.

Note that at least a part of the tables C1300, C1400, C1500, and C1600 in the ECU gateway C11 may exist in the user device U1000 or in the OTA server system T1000 instead of or in addition to the vehicle V1000 (for example, the ECU gateway C11). At least a part of the table T1400 in the OTA server system T1000 may be provided in at least one of the vehicle V1000 (for example, the ECU gateway C11) and the user device U1000 instead of or in addition to the OTA server system T1000. The preliminary determination program T61 may be provided in at least one of the vehicle V1000 (for example, the ECU gateway C11) and the user device U1000 instead of or in addition to the OTA server system T1000. The function setting program C14 may be included in at least one of the OTA server system T100 and the user device U1000 instead of or in addition to the vehicle V1000 (for example, the ECU gateway C11). The hardware configuration of the vehicle is not limited to the configuration including the ECU. In addition, communication between the OTA server system T1000 and the ECU gateway C11 performed via or not via the user device U1000.

In addition, as described above, the OTA server system T1000 may be the server system at the company or OEM site that provides the vehicle sharing service (or rental service).

In addition, in a case where there is a plurality of users for the vehicle V1000, the user-side software table C1600 for each user may be provided in the vehicle V1000.

In addition, a timing at which the user-desired function group is implemented in the vehicle V1000 may be a timing at which the user rides in the vehicle V1000 and the user instructs the vehicle V1000 to implement the user-desired function group via or not via the user device U1000, or may be any timing before the user rides in the vehicle V1000. In addition, the user-desired function group may be registered in the vehicle V1000 for all the users.

### Second Embodiment

A second embodiment will be described. At that time, differences from the first embodiment will be mainly described, and description of points common to the first embodiment will be omitted or simplified.

The first embodiment is an embodiment in a case where it is determined that the user uses the vehicle V1000, but in the second embodiment, the user can prioritize implementation of the user-desired function group over riding in the vehicle V1000.

FIG. 17 illustrates an example of a flow of entire processing performed in the second embodiment.

In a case where the user prioritizes riding in the vehicle V1000 (S501: Yes), the processing illustrated in FIG. 13 is performed.

In a case where the user prioritizes the implementation of the user-desired function group over riding in the vehicle V1000 (S501: No), the preliminary determination program T61 determines a relationship between one or a plurality of user-desired functions constituting the user-desired function group of the user and the hardware configuration of the vehicle based on the function definition table T1400 for each of one or a plurality of vehicles satisfying a predetermined condition in the preliminary determination in S502. In the determination, the preliminary determination program T61 determines the presence or absence of a corresponding vehicle that is a vehicle having a hardware configuration corresponding to the user-desired function group (for example, a function group specified from at least one of the user setting table and the user-side software table). The “predetermined condition” referred to here may be at least one of one or more requirements such as being in a geographical range (for example, an area such as cities, towns, and villages, or a range of a predetermined distance from a point designated by the user) designated by the user and such as that the vehicle corresponds to the type of vehicle designated by the user.

When there is a corresponding vehicle (S502: Yes), the preliminary determination program T61 (or a program communicating with the preliminary determination program T61) may display a list of vehicle IDs of the corresponding vehicle and receive selection of the vehicle desired by the user from the list in S503. The list may be displayed on, for example, the display device of the in-vehicle apparatus or a user device. Thereafter, the processing of FIG. 13 may be performed. However, S103 is executed without going through S102 and S107.

When there is no corresponding vehicle (S502: No), the preliminary determination program T61 (or a program communicating with the preliminary determination program T61) may display the list of the vehicle IDs of the vehicle, and receive selection of the vehicle desired by the user from the list in S504. The vehicle ID displayed here may be a vehicle ID of a vehicle having a hardware configuration corresponding to as many functions as possible of the user-desired function group, or may be vehicle IDs of all the vehicles of “one or a plurality of vehicles satisfying a predetermined condition” referred to in S502. After the selection of the vehicle ID from the list, the processing of FIG. 13 may be performed. However, although S102 is skipped, S103 is executed after going through S107.

In the second embodiment, the vehicle in which the software configuration is developed for each function in S105 is the vehicle selected in S503 or S504.

In the second embodiment, the user can know the vehicle in which the user-desired function group is implemented and decide to ride in the vehicle.

Although some embodiments have been described above, these are examples for describing the present invention, and it is not intended to limit the scope of the present invention only to these embodiments. The present invention can be implemented in various other forms.

### REFERENCE SIGNS LIST

T61 preliminary determination program
C14 function setting program
V1000 vehicle

1. A vehicle setting system comprising:
a preliminary determination unit configured to perform a preliminary determination including a determination of a relationship between one or a plurality of user-desired functions constituting a user-desired function group of a user and a hardware configuration of a target vehicle, based on function definition information that is information representing a correspondence relationship among a software-based function, a vehicle ID of a vehicle, a hardware configuration for implementing a function, and a software configuration for implementing a function; and
a function setting unit configured to, for each of the one or more functions specified in the preliminary determination, develop a software configuration corresponding to the function in the hardware configuration corresponding to the function in the target vehicle, in order to implement the function in the target vehicle.

2. The vehicle setting system according to claim 1, wherein
the preliminary determination unit performs the preliminary determination when user-side information that is information representing a relationship between the vehicle and the user-desired function group does not include the user-desired function group corresponding to the target vehicle in advance.

3. The vehicle setting system according to claim 2, further comprising:
a restriction notification unit configured to notify the user of function restriction information, which is information representing a part of the specified one or more functions, in a case where the part of the specified one or more functions is not the user-desired function,
wherein the function setting unit develops the software configuration corresponding to each of the specified one or more functions when the user approves the function restriction information.

4. The vehicle setting system according to claim 1, wherein
for each software-based function,
the hardware configuration for implementing the function includes a version of an electronic control unit (ECU) of the vehicle, and
the software configuration for implementing the function includes a version of at least one of an application, middleware, an operating system (OS), and a hypervisor.

5. The vehicle setting system according to claim 1, wherein
information representing the user-desired function group of the user is stored in any one of the target vehicle, a user device that is an information processing device of the user and is a device capable of communicating with the target vehicle, and a server system capable of communicating with at least one of the target vehicle and the user device,
the preliminary determination unit is provided in at least one of the server system, the target vehicle, and the user device, and
the function setting unit is provided in at least one of the server system, the target vehicle, and the user device.

6. The vehicle setting system according to claim 1, wherein
for each of the one or more functions,
when the target vehicle does not have a part of the software configuration corresponding to the function, the function setting unit determines whether partial update of the software configuration corresponding to the function is possible based on software definition information in which a software configuration that can be partially updated is defined,
when a result of the determination is true, development of the software configuration corresponding to the function includes the partial update of the software configuration in a memory of the vehicle, and
when the result of the determination is false, the development of the software configuration corresponding to the function includes deletion of an entire software configuration in the memory of the vehicle and development of the entire software configuration corresponding to the function in the memory.

7. The vehicle setting system according to claim 1, wherein
in the preliminary determination, the target vehicle is each of one or a plurality of vehicles satisfying a predetermined condition, and
the target vehicle in which the software configuration is developed for each function in the user-desired function group is a vehicle that satisfies a certain condition for the user-desired function group and is selected by the user from one or more target vehicles specified in the preliminary determination among the one or plurality of vehicles.

8. A vehicle setting method comprising:
performing, by a computer, a preliminary determination including a determination of a relationship between one or a plurality of user-desired functions constituting a user-desired function group of a user and a hardware configuration of a target vehicle, based on function definition information that is information representing a correspondence relationship among a software-based function, a vehicle ID of a vehicle, a hardware configuration for implementing a function, and a software configuration for implementing a function; and
developing, by the computer, for each of the one or more functions specified in the preliminary determination, a software configuration corresponding to the function in a hardware configuration corresponding to the function in the target vehicle, in order to implement the function in the target vehicle.

9. A server system comprising:
a preliminary determination unit configured to perform a preliminary determination including a determination of a relationship between one or a plurality of user-desired functions constituting a user-desired function group of a user and a hardware configuration of a target vehicle, based on function definition information that is information representing a correspondence relationship among a software-based function, a vehicle ID of a vehicle, a hardware configuration for implementing a function, and a software configuration for implementing a function; and
a function notification unit configured to notify the target vehicle of information representing one or more functions specified in the preliminary determination.
